(19) United States
(12) Patent Application Publication
(10) Pub. No.: US 2014/0278790 A1
(43) Pub. Date: Sep. 18, 2014

(54) SYSTEM AND METHOD FOR DATA ACQUISITION, DATA WAREHOUSING, AND PROVIDING BUSINESS INTELLIGENCE IN A RETAIL ECOSYSTEM

(71) Applicant: SPS Commerce, Inc., Minneapolis, MN (US)

(72) Inventors: Kurt Wolff, Wayzata, MN (US); Rob Krystyniak, Dover, NJ (US); Frank DeLuccia, West Orange, NJ (US); Sandra Alpizar, Montclair, NJ (US)

(73) Assignee: SPS Commerce, Inc., Minneapolis, MN (US)

(21) Appl. No.: 14/210,577

(22) Filed: Mar. 14, 2014

Related U.S. Application Data
(60) Provisional application No. 61/793,022, filed on Mar. 15, 2013.

(51) Int. Cl. G06Q 30/02

(52) U.S. Cl. CPC G06Q 30/0201
USPC 705/7.32; 705/7.29

(57) ABSTRACT

A method for providing consistently formatted data relating to the exchange of goods in a retail ecosystem. The method may generally include acquiring data relating to the exchange of goods from at least one supplier and at least one retailer, normalizing the acquired data and storing the normalized data in one or more structured databases, and providing business intelligence tools, accessible to the at least one supplier and at least one retailer for accessing the one or more structured databases. The business intelligence tools may provide consistently formatted data from the structured databases to each of the at least one suppliers and consistently formatted data from the structured databases to each of the at least one retailers.

### CROSS-REFERENCE TO RELATED APPLICATIONS

The present application claims the benefit of U.S. Prov. Pat. Appl. No. 61/793,022, filed Mar. 15, 2013, titled “System and Method for Data Acquisition, Data Warehousing, and Providing Business Intelligence in a Retail Ecosystem,” the contents of which are incorporated by reference herein in their entirety.

### FIELD OF THE INVENTION

The present disclosure relates to retail ecosystems and supply chain management. Particularly, the present disclosure relates to systems and methods for data acquisition, data warehousing, and providing business intelligence in a retail ecosystem with particular focus on supply chain management. More particularly, the present disclosure relates to systems and methods for trading partner intelligence among retailers and suppliers in the retail ecosystem.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The supply chain management industry serves thousands of retailers around the world, speeding the ordering, fulfillment, and disposition of goods and services from tens of thousands of suppliers. Additional participants in this market include distributors, third-party logistics providers, manufacturers, fulfillment and warehousing providers, factoring firms, and sourcing companies. This network of participants can be defined as a retail ecosystem comprised of a network of organizations—including suppliers, distributors, customers, competitors, government agencies, and others involved in the delivery of a specific product or service through both competition and cooperation. The idea is that each business in the “ecosystem” affects and is affected by the others, creating a constantly evolving relationship in which each business must be flexible and adaptable in order to survive, as in a biological ecosystem.

More and more, retailers are counting on suppliers to understand and help manage their own products' performance at the store/retail level. In order to do so, an increasing number of retailers provide Point of Sale (POS) data to vendors so that suppliers can perform their own analysis and help the retailers make better business decisions. In this regard, supply chain management now involves communicating data related to the exchange of goods among the trading partners in the retail ecosystem.

Often, however, standards do not generally permit instant connection between any retailer with any other participant in the supply chain. Furthermore, at every stage of the supply chain, there are inefficient, labor-intensive processes between trading partners with significant documentation requirements, such as the counting, sorting and verifying of goods before shipment, while in transit, and upon delivery.

Supply chain management solutions in this retail ecosystem must address trading partners' needs for integration, collaboration, connectivity, visibility and data analytics to improve the speed, accuracy, and efficiency with which goods are ordered and supplied. Conventional methods involve manual analysis of various versions of printed specifications. All analysis under the conventional methods is done in the context of a specific relationship within the retail ecosystem and as a result, there was no universal standard or means of automating the testing of that standard against various specifications.

This type of limitation led to development and implementation of the present disclosure. A significant hurdle to overcome was to efficiently analyze, categorize, and manage the sheer number of connections that exist between retailers and other participants of the retail ecosystem as well as the customization, categorization, integration, and deployment of each new connection. Therefore there is a need to develop systems and methods to eliminate the current inefficiencies of the current supply chain management data intake and to develop systems and methods for rapidly integrating, categorizing, and managing such intake data, and for providing analytic tools to participants in the retail ecosystem for the intake data.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a method for providing consistently formatted data relating to the exchange of goods in a retail ecosystem. The method may generally include acquiring data relating to the exchange of goods from at least one supplier and at least one retailer, normalizing the acquired data and storing the normalized data in one or more structured databases, and providing business intelligence tools, accessible to the at least one supplier and at least one retailer for accessing the one or more structured databases. The business intelligence tools may provide consistently formatted data from the structured databases to each of the at least one suppliers and consistently formatted data from the structured databases to each of the at least one retailers.

The present disclosure, in another embodiment, relates to a method for providing business intelligence information relating to the exchange of goods in a retail ecosystem. The method may generally include acquiring electronic data, through an electronic network, from a plurality of trading partners of the retail ecosystem, the electronic data relating to goods exchanged between the trading partners, transforming the electronic data to a normalized format, and storing the transformed data in the normalized format in a plurality of structured databases stored on a computer-readable storage medium, wherein at least one structured database is associated with each trading partner. The method may further include presenting through a business intelligence tool, accessible to the trading partners through an electronic network and displayable on an electronic display device, data from one or more of the structured databases in a predetermined report structure. In some embodiments, acquiring electronic data may include polling one or more of the trading partners through the electronic network for new data and acquiring the new data. Additional embodiments may include monitoring metadata to identify whether data was expected to be received by any given trading partner. The method can include supplementing data in a first of the structured databases automatically with data from a second of the structured databases. In some cases, the first structured database is associated with a retailer and the second structured database is associated with a supplier of the retailer. In other cases, the first structured database is associated with a supplier and the second structured database is associated with a retailer purchasing product from the supplier. In a particular embodiment, at least a portion of the electronic data stored in each of the structured databases includes sets of data, each set of data identifying a product sold, when the product was sold, and to where the product was sold. The predetermined report structure presented through the business intelligence tool, in some embodiments, is defined by a set of report rules. In some cases, the report rules for at least some of the predetermined reports are defined by non-trading partners. In other cases, the report rules for a predetermined report accessible to a given trading partner are defined by that trading partner. In certain embodiments, the business intelligence tool may be a suite of business intelligence tools. In still further embodiments, the method may include determining an access level for a user of a given trading partner and basing authorized access by the user to the business intelligence tools and/or data in the plurality of structured databases based on the determination of the access level for the user. In one embodiment, any given trading partner may subscribe to one or more of the business intelligence tools, providing access by the given trading partner to only those business intelligence tools subscribed to.

The present disclosure, in still another embodiment, relates to a system for providing business intelligence information relating to exchanges of goods in a retail ecosystem. The system may include a communications subsystem, operably connected with an electronic network, acquiring electronic data, through the electronic network, from a plurality of trading partners of the retail ecosystem, the electronic data relating to goods exchanged between the trading partners. The system may also include a data warehousing subsystem transforming the electronic data to a normalized format and storing the transformed data in the normalized format in a plurality of structured databases stored on a computer-readable storage medium, wherein at least one structured database is associated with each trading partner. The system may further include a business intelligence tool, accessible to a given trading partner through an electronic network and displayable on an electronic display device, the business intelligence tool presenting at least a portion of the data from at least one structured database associated with the given trading partner in a predetermined report structure. In some embodiments, at least a portion of the electronic data stored in each of the structured databases includes sets of data, each set of data identifying a product sold, when the product was sold, and to where the product was sold. The business intelligence tool of the system may be a suite of business intelligence tools. In some embodiments, at least one of the business intelligence tools is a spreadsheet report generator that produces an interactive spreadsheet report based on data from one or more of the plurality of structured databases. In some embodiments, at least one of the business intelligence tools is a business intelligence report generator that produces a report for a given trading partner relating to data from one or more of the plurality of structured databases based on ad-hoc reporting options selected by the given trading partner. In yet other embodiments, at least one of the business intelligence tools is a dashboard utility that generates an Internet-based dashboard display for a given trading partner relating to data from one or more of the plurality of structured databases based on a predetermined configuration defined for that given trading partner. In one embodiment, the predetermined configuration defined for that given trading partner may be based on attributes pre-selected by the given trading partner.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic illustration of a data acquisition subsystem in accordance with one embodiment of the present disclosure.

FIG. 2 is a schematic illustration of a data warehousing subsystem in accordance with one embodiment of the present disclosure.

FIG. 3 is a logical diagram of a supplier or retailer database in accordance with one embodiment of the present disclosure.

FIG. 4 is a schematic illustration of a business intelligence application subsystem in accordance with one embodiment of the present disclosure.

FIG. 5 is a schematic illustration of a network portal subsystem in accordance with one embodiment of the present disclosure.

### DETAILED DESCRIPTION

The present disclosure relates to retail ecosystems and supply chain management. Particularly, the present disclosure relates to novel and advantageous systems and methods for data acquisition, data warehousing, and providing business intelligence in a retail ecosystem with particular focus on supply chain management. More particularly, the present disclosure relates to novel and advantageous systems and methods for trading partner intelligence among retailers and suppliers in the retail ecosystem.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor or flat-screen display, a printer, and speakers or any device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a local or global computer information network, such as a LAN, WAN, or the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. A code segment of the computer-executable program code may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, wireline, optical fiber cable, radio frequency (RF) signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the C programming language or similar programming languages.

Various embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of or “generally free of an ingredient or element may still actually contain such item as long as there is generally no measurable effect thereof.

As described above, the supply chain management industry serves thousands of retailers around the world, speeding the ordering, fulfillment, and disposition of goods and services from tens of thousands of suppliers. The network of participants in this industry can be defined as a retail ecosystem comprising a network of organizations—including suppliers, distributors, customers, competitors, government agencies and others involved in the delivery of a specific product or service through both competition and cooperation. Each business in the “ecosystem” affects and is affected by the others, creating a constantly evolving relationship in which each business must be flexible and adaptable in order to survive, as in a biological ecosystem.

Supply chain management involves communicating data related to the exchange of goods among these trading partners in the retail ecosystem in order to determine, among other things, when additional supply is necessary and/or how well a product is doing in the market. However, standards do not generally permit instant connection between any retailer with any other participant in the supply chain. Additionally, at every stage of the supply chain, there are inefficient, labor-intensive processes between trading partners with significant documentation requirements, such as the counting, sorting, and verifying of goods before shipment, while in transit, and upon delivery. Such problems have been addressed in commonly-owned U.S. patent application Ser. No. 14/169,347, filed Jan. 31, 2014, titled “Data Acquisition, Normalization, and Exchange in a Retail Ecosystem,” the contents of which are incorporated herein by reference in their entirety.

The present disclosure provides additional solutions for participants in this retail ecosystem that address trading partners' needs for integration, collaboration, connectivity, visibility, and data analytics, which in turn improve the speed, accuracy, and efficiency with which goods are ordered and supplied. As previously stated, conventional methods for supply chain management involve manual analysis of various versions of printed specifications, with all analysis being done in the context of a specific relationship within the retail ecosystem. As a result, there was no universal standard or means of automating the testing of that standard against various specifications.

The various embodiments of the present disclosure improve on the methods for efficiently analyzing, categorizing, and managing the number of connections that exist between retailers and other participants of the retail ecosystem and eliminates many of the current inefficiencies with conventional supply chain management data intake, integration, categorization, and management, and provides analytic tools to participants in the retail ecosystem for analyzing the supply chain management intake data and using the analytic results in making intelligent business decisions.

In general, the various embodiments of the present disclosure relate to systems and methods for data acquisition, data warehousing, and providing business intelligence in a retail ecosystem with particular focus on supply chain management. More particularly, the present disclosure relates to novel and advantageous systems and methods for what is referred to herein as trading partner intelligence among retailers and suppliers in the retail ecosystem.

The various embodiments of the present disclosure involve acquiring data related to the exchange of goods, such as point-of-sale (POS) data, among participant trading partners of a retail ecosystem, validating and transforming or normalizing the acquired data for consistency, and loading the transformed data into a data warehouse. Essentially, the various embodiments of the present disclosure provide a novel and advantageous means for acquiring data related to the exchange of goods, which may be represented in a variety of different formats and which may have been calculated by different trading partners under inconsistent metrics standards, and normalizing the data so that it can be presented to trading partners as participants in the system in a consistent and meaningful manner, permitting the participant trading partners to make better business decisions. Through the normal data flow of documents between participant trading partners, the various embodiments of the present disclosure may be configured to learn about, and provide a complete picture of, the relationship between any given supplier or suppliers and any given retailer or retailers with respect to a given product, simply by combining portions of the normalized data in a predefined or structured manner. The various embodiments of the present disclosure may be configured to transform and present data for evaluation based on a plurality of rules, depending on the evaluation requested. Retailers and suppliers, as participants of the systems and methods of the present disclosure, may utilize such transformed data to make intelligent supply chain management or other business decisions.

In one embodiment, such a supply chain management, or trading partner intelligence, system and method may generally include four higher level logical subsystems. These subsystems may include: data acquisition; data warehousing; business intelligence applications; and a network, or web/internet, portal. Together, these subsystems may generally be responsible for receiving, normalizing, and loading POS data into data warehouses, populating reports based on analytics of the data, and distributing the reports via the web to the end trading partner participants. Each subsystem may additionally have its own quality control mechanisms, ensuring the validity and quality of the intake POS data and analysis of the same.

The data acquisition subsystem 100, schematically illustrated in FIG. 1, may comprise three general aspects: communications, EDI mapping/translation, and monitoring/alerting. A communications layer 102 may manage and administer all communications between the system and the participant trading partners 104, e.g., retailers 106 and suppliers 108. In one particular embodiment, although not so limited, the communications layer 102 may be the Electronic Commerce Server (ECS) provided by Liaison® Technologies, with U.S. Headquarters in Atlanta, Ga.

Generally, the communications layer 102 may be configured to poll for new POS data, or otherwise receive new POS data, associated with the participant trading partners 104 via various data sources, such as but not limited to, via FTP (File Transfer Protocol) or sFTP (SSH File Transfer Protocol), AS2 (Applicability Statement 2 protocol), a VAN (Value-Added Network), HTTP (Hypertext Transfer Protocol), and/or another web server, each which may be communicatively reached via a connection to a network, such as the Internet 110. When new data is present, the communications layer 102 may acquire the data file. The communications layer 102 may further catalog retrieval of the data file in metadata associated with the data file. The communications layer 102, in some embodiments, may store the raw data file as received in a raw data archive 112 so as to maintain a record of data as received, if access to such data becomes desirable, such as for verification and validation or for backup. In general, the communications layer 102 may perform some actions on the retrieved data and place the data in the system for subsequent downstream processing.

Retailers, suppliers, and other trading partners often harness the efficiencies of Electronic Data Interchange (EDI) as the mode of communication between parties. EDI, in a sense, may be most easily understood as the replacement of paper-based purchase orders and other POS data with electronic equivalents. The basic elements of an EDI architecture are: the use of an electronic transmission medium (e.g., the Internet or other network); the use of structured, formatted content that may comply with one or more standards or specifications (such that messages can be translated, interpreted, and checked for compliance); delivery of electronic documents from sender to receiver; and direct communication between applications (rather than merely between computers). In one embodiment, a particular participant trading partner's EDI data standard may define an EDI syntax, business rules, and timeliness. Business rules may be written in a flexible language to describe complicated customized business logic which is specific to a given supplier/retailer and industry. Timeliness of an EDI may be defined on a per retailer and per document basis so as to meet the individual needs of a participant trading partner.

In some embodiments, the communications layer 102 may take advantage of the efficiencies provided by retrieved data falling within the EDI architecture. It is recognized, however, that the various embodiments of the present disclosure may receive or retrieve electronic documents under any suitable format, including but not limited to, EDI, Extensible Markup Language (XML), and flat file architectures, which are also often used by retail ecosystem participants for communication in order to facilitate the electronic transfer of information. XML, as will be recognized by those skilled in the art, is a markup language utilized to tag documents for navigation. A flat file architecture, as used herein, includes a plain text file, usually containing one record per line, a binary file, or the like. Within such a record, the single line records can be separated by delimiters such as comma (e.g., in a comma-separated values (.csv) file) or tab characters, or may each have a fixed length.

Generally, the EDI mapping or translation 114 may generally normalize any received EDI data to a consistent data file structure, such as a common format text (.txt) file, and stored in a system or network file system 116. Specifically, in one embodiment, if a file received or retrieved by the communications layer 102 is determined to be EDI, it is passed to an EDI mapping process 114, where the file in EDI data format is translated into a normalized consistent structure and stored as a common .txt file, which is then stored in memory on the system for subsequent downstream processing and integration. In one embodiment, the EDI files may be processed by ECS—Delta, also provided by Liaison® Technologies. Additional or alternative forms of transformation or translation to a consistent or normalized format are described in commonly-owned U.S. patent application Ser. No. 14/169,347, which was previously incorporated herein.

In further embodiments, if the file received or retrieved by the communications layer 102 is not EDI, the file may be simply maintained in its original format, which may often be an XML or common .txt or .csv format, on a system or network file system 118 for subsequent processing. Oftentimes, files that are received or retrieved in a format other than EDI may be provided by trading partners having a specified relationship defined between the trading partner and the system or system owner, which may define and/or specify, for example but not limited to, the type, amount, and format of the data being sent. Such data files may typically include more data, or an expanded set of metrics, than would be provided in a standard EDI file. As will be discussed in more detail below with respect to data warehousing, downstream processing may be configured to process these data files according to the data stored therein, and according to the relationship agreement between the trading partner and the system or system owner.

In some embodiments, the various embodiments of data acquisition of the present disclosure may additionally include intelligence, via metadata for example, to identify whether any data expected to be received is missing or late. More specifically, as indicated above, the communications layer 102 may catalog retrieval of data files in metadata associated with the data file. If a certain data source is scheduled to be polled for retrieval of data for a specified participant or for other specified data at a predetermined time, the system may include tools, monitors, processes, or the like to confirm retrieval of the data and/or identify whether the specified data has not been retrieved, is not retrievable, or is otherwise missing or late. If data has been identified as irretrievable or is otherwise missing or late, additional steps may be taken to resolve the retrieval of the data, which may include follow-up with the participant trading partner to identify the cause of the missing data.

At any rate, the general result of data acquisition, in one embodiment, is one or more file systems holding data files waiting for downstream processing by the data warehousing system. In general, the data warehousing subsystem 200, schematically illustrated in FIG. 2, may utilize Extract, Transform, and Load (ETL) tools to access the files systems 116, 118, process the data files, and load them into appropriate databases. ETL commonly refers to a process in database usage, and especially in data warehousing, that involves extracting data from outside sources, transforming the data to fit operationally, and loading the data into an end target, such as a database, and more specifically, an operational data store, data mart, or data warehouse.

More specifically, after the data acquisition subsystem 100 makes a data file available on the file system, ETL or other integration tools may parse the data files and load the raw data contained therein into structured databases. In one embodiment, this integration may be carried out, for example, utilizing SQL Server Integration Services such as SQL Server Agent Jobs, although PERL scripts or .NET code may additionally be desirable for advanced parsing; of course, any other integration tools may be utilized as desired. Regardless of the means for parsing and loading mechanism, the parsed data may be imported into one or more structured databases for even further processing.

In one embodiment, data files from file system 116, which comprises normalized common format .txt files or other normalized format files translated from EDI files or other conventionally formatted files, as described above, may be processed utilizing ETL or other integration tools and the data contained therein may be loaded into a central hub database 202, which generally acts as a router or switchboard to port the data into appropriate supplier databases 204 in a repository 206 of supplier databases and/or appropriate retailer databases 208 in a repository 210 of retailer databases.

In one embodiment, for any given trading partner (e.g., retailer or supplier), the appropriate databases 204, 208 may be created or generated by manual entry upon addition of such trading partner to the retail ecosystem. In other embodiments, however, one or more of the appropriate databases 204, 208 may be automatically or semi-automatically generated for a given trading partner upon addition of such trading partner to the retail ecosystem. For example, in one embodiment, an application interface may be provided for receiving input of predetermined data or metadata about the trading partner and the systems for data acquisition, data warehousing, and providing business intelligence in a retail ecosystem described herein may automatically generate or create one or more appropriate databases 204, 208 for the trading partner based, at least in part, on the data input to the application interface. In one embodiment, as illustrated in FIG. 2, the appropriate databases 204, 208 may comprise a set of databases for each trading partner. One benefit of such semi-automatic or automatic creation of databases 204, 208 is consistency among the structure of the databases across all trading partners, generally providing a normalized data warehouse. Another benefit of such semi-automatic or automatic creation of databases 204, 208 is improved or easy scalability. That is, it becomes relatively easier to add trading partners to the retail ecosystem or to the systems for data acquisition, data warehousing, and providing business intelligence in a retail ecosystem described herein.

At the central hub database 202 and/or within each supplier database 204 and/or within each retailer database 208, the system may “cleanse” and normalize the data into a highly normalized format. Some forms of transformation or translation to a consistent or normalized format are described in commonly-owned U.S. patent application Ser. No. 14/169,347, which was previously incorporated herein. This normalizing can provide significant value and benefits, since, as described above, data in many different file formats (e.g., EDI, .txt, .csv) or developed under different standards may be received or retrieved by the data acquisition subsystem 100. In this regard, the system permits each participant trading partner, e.g., supplier and/or retailer, to customize their own database 204, 208, within a certain framework, while also permitting a structured normalized environment for consistent downstream reporting. Each database 204, 208 may be controlled by a master stored procedure which may execute on a particular trading partner's database(s) periodically, such as but not limited to every hour, every two hours, etc. This master stored procedure may execute the steps of normalization and cleansing, and may aggregate the data for downstream reporting, as will be discussed in further detail below. In one embodiment, the master stored procedure may be effected utilizing Transact SQL, with execution of the master procedure triggered via a SQL Agent Job.

As indicated above, oftentimes, files that are received or retrieved in a format other than EDI may be provided by trading partners having a specified relationship defined between the trading partner and the system or system owner, which may define and/or specify, for example but not limited to, the type, amount, and format of the data being sent. These “relationship” trading partners, may agree to send more robust, unique, and/or thorough datasets than non-partnered trading partners, which typically provide data in a standard EDI file. Relationship trading partners, in one embodiment, may typically be partnered retailers, which often have the ability to provide such robust and thorough datasets through their supply management systems. As described above, files from such relationship trading partners may be simply maintained in its original format, which may often be an XML or common .txt or .csv format, on system or network file system 118. At the data warehousing system 200, like data from file system 116, such data from file system 118 may also be processed utilizing ETL or other integration tools and the data contained therein may be loaded into appropriate retailer databases 208 in a repository 210 of retailer databases. Retailer databases for relationship trading partners, such as partnered retailers, may generally be more configurable and customizable to a particular retailer's data model.

In further embodiments, data from file system 118 may be routed from the retailer databases 208 via the central hub database 202 to specified supplier databases 204 to supplement the supplier databases or vice versa. Particularly, for example, if a supplier is known to report on a given partnered retailer, certain data from file system 118, which as described above may be more robust, unique, and/or thorough, relating to the relationship between that partnered retailer and the supplier could be ported into that supplier's database where the data may supplement any data provided by the supplier, thereby adding value to the supplier's database. Through this supplemental data, additional and specific information may be gleaned about any particular supplier and retailer relationship. For instance, an initial EDI from a supplier may only reference a supplier/vendor part number, while a supplemental data file from the corresponding retailer, possibly coming from file system 118, may additionally provide a retailer/buyer part number. The application can supplement the initial EDI with the retailer data in order to associate the vendor and buyer part numbers. The foregoing, of course, is only one example, and this type of supplementing has broad application to the data and is not limited to solely associating vendor and buyer part numbers. In general, however, through this supplementing means, the system can learn and report on a complete picture of the supplier and retailer relationships.

In general, the supplier 204 and retailer 208 databases may comprise data in a normalized and consistent structure and format. As illustrated in FIG. 3, a supplier 204 or retailer database 208 may comprise a core fact data table 302 identifying one or more fact actions, such as, for example but not limited to, unit sales, unit transactions, units in transfer, or the like. Each fact action in fact data table 302 may be associated with Time 304, Item 306, and/or Location 308 attributes. Generally, the Time attribute 304 for a fact action may specify a point in time for the fact action, such as, for example but not limited to, a time of sale. The Item attribute 306 for a fact action may specify the item or product associated with the fact action, such as by but not limited to, the item's or product's Universal Product Code (UPC). The Location attribute 308 for a fact action may specify a location associated with the fact action, such as, for example but not limited to, to what retailer or store (by store number, for example) the units of the fact action were sold or where the units were transported. In general, the supplier 204 or retailer 208 databases may comprise data in consistent formats that specify what was sold, where it was sold to, and when it was sold for any given transaction. Of course, any number of other attributes 310 associated with any given fact action may also be provided, and attributes are not limited to Time, Item, and Location. Other data from the supplier, such as but not limited to, item master product files or defined location data metrics specific to that supplier or retailer may also be integrated with the data in the supplier 204 and/or retailer 208 databases. In general, as long as a piece of data can tie (or key) to a time, item, location, or other attribute associated with a fact action, it may be merged with the data in an appropriate supplier 204 or retailer 208 database during data warehousing. From these core tables, data can be aggregated up into many different hierarchical levels based on any of those attributes. For example, data can be aggregated for a high level categorization of one or more product, or into particular time intervals, such as Year-to-Date sales.

With reference back to FIG. 2, ETL or other integration tools may be utilized to transfer or further parse the data files into one or more structured secondary supplier and/or retailer databases 212. The secondary supplier and/or retailer databases 212 may be “live,” internet facing databases, which may generally be accessible to the participant trading partners directly and/or through front facing tools available to the participant trading partners. Secondary supplier and/or retailer databases 212 may include duplicate data from the corresponding supplier 204 and/or retailer databases 208 or may comprise data from the corresponding supplier 204 and/or retailer databases 208 which has been further structured, normalized, or even denormalized or otherwise organized for a particular downstream analytics application or other front facing business intelligence tool available to the participant trading partners. In one embodiment, as illustrated in FIG. 2, secondary supplier and/or retailer databases 212 may include a database particularly configured or reserved for supplier report building 214 and databases 216, 218 particularly configured or reserved for populating dashboard interfaces for each supplier and retailer. Providing secondary supplier and/or retailer databases 212 permits the system to separate end-user accessible databases, e.g., 212, from the back end system databases, e.g., 204, 208, therefore maintaining the integrity of the system databases, while permitting substantial access to the participant trading partners to their data.

At any rate, the general result of data warehousing, in one embodiment, is one or more supplier 204 and/or retailer 208 databases and optionally one or more secondary supplier and/or retailer databases 212 populated with normalized data ready and waiting for reporting to the participant trading partners via one or more business intelligence (BI) applications. In general, the BI applications subsystem 400, schematically illustrated in FIG. 4, may comprise one or more BI applications which may access and query one or more of the databases 204, 208, 212 and generate specific reports or otherwise respond to specific requests for data from participant trading partners. In one embodiment, the BI applications may transform and prepare the specific reports or responses in accordance with a defined set of rules. For example, a BI application may be used to intelligently combine data relating to currency, items, locations, and POS numbers into a consistent and consolidated structure which can provide additional insight into the meaning of individual data points. A more detailed example of this includes the ability see how red versus yellow apparel is selling in Mexico, expressed in U.S. dollars. Of course, this is but one example, and many other intelligent combinations of data may be utilized to create meaning and consistent reports to participant trading partners upon which they can make better supply chain decisions, such as when additional supply is necessary and/or determining how well a product is performing.

In one particular embodiment, illustrated in FIG. 4, the BI applications subsystem 400 may include three different BI applications for querying respective databases and generating specific reports or otherwise responding to specific requests from participant trading partners: a Spreadsheet Report Generator 402; a BI Report Generator 404; and a Dashboard Creator 406. While a variety of BI applications may be provided, including these or others, for reporting data to participant trading partners in various manners or with varying scopes of meaningful information, participant trading partners need not have access to each BI application, and in some embodiments, the participant trading partners may be able to opt for which BI applications to which they would like access.

While generally described herein as separate BI applications, which may originate from different channels or sources, in other embodiments two or more of the BI applications may originate from the same channel or source or may be portions of a larger BI application. For example only, the BI Report Generator 404 and Dashboard Creator 406 could each be part of a larger encompassing BI application originating from the same source. Embodiments where multiple BI applications originate from the same source can provide additional advantages. For example, it would generally be easier to maintain the BI applications where such multiple BI applications originate from a single channel or source. For similar reasons, performance of the applications can be increased, providing overall positive user experiences. Additionally, it makes it easier for trading partners to seamlessly scale up or scale down the number of BI applications to which they subscribe or otherwise have access.

The Spreadsheet Report Generator 402 may be used to produce one or more interactive reports or tables 408 that automatically extract, organize, and/or summarize data directly from a supplier's 204 or retailer's 208 database(s) (or front-facing database(s) 212) for that particular participant supplier or retailer. These reports may be used by the participant supplier or retailer to analyze the data, make comparisons, detect patterns and/or relationships, and/or discover trends in order to make better supply chain decisions, such as when additional supply is necessary and/or determining how well a product is performing. The Spreadsheet Report Generator 402 may be configured to periodically, such as once a week, provide one or more reports to each corresponding participant trading partner from their corresponding database in a substantially consistent format for that individual trading partner. Furthermore, these reports may be generated in a substantially consistent format across all participant trading partners. In still further embodiments, the reports may be provided at request (or on-demand) by a participant trading partner, may be provided whenever data is available to report on or when data has been updated, or may be provided in any other suitable manner, including randomly or arbitrarily.

In one embodiment, the Spreadsheet Report Generator 402 may generate Microsoft® Excel® Pivot Table reports. In one embodiment, an application, such as but not limited to a .Net application, may leverage available plugins and template files and utilize metadata definitions for the reports. In one embodiment, once the Spreadsheet Report Generator 402 has identified that data is available for access, a report may be generated. According to a particular embodiment, this process may be controlled by a Windows® Service that polls the supplier 204 and/or retailer 208 databases and identifies whether data is available and ready to report on. The Spreadsheet Report Generator 402 may retrieve the data it needs, which may be determined via the metadata definitions for the reports, and may identify a predetermined report template that the data may be put into, which may also be determined via the same metadata definition. The Spreadsheet Report Generator 402 may then create a spreadsheet file, such as an Excel® file, with the data populated, for example, into the cache of the physical file. The file is placed on the file system for subsequent downstream presentation via a network portal or similar web application, described in further detail below.

The BI Report Generator 404 may generally provide “live” databases to the participant trading partners, on which each participant trading partner may select from a variety of ad-hoc reporting options. The BI Report Generator 404 may take advantage of pre-aggregated and summarized data. In one embodiment, the BI Report Generator 404 may utilize a third-party platform, such as that provided by MicroStrategy®, with Corporate Headquarters in Tysons Corner, Va. The MicroStrategy® platform, for example, may provide a full functioning BI implementation overlaid on at least one of the supplier and/or retailer databases 204, 208, 212, and in one particular embodiment, overlaid on the supplier report builder database 214. If third-party tools, such as the MicroStrategy® platform, are utilized, those platforms may be configured to poll the underlying database or databases and may identify when new data is available. These third-party platforms may further be configured to pull the new data from selected databases and bring that data into their own databases, if desired or otherwise configured as such. In this regard, the third-party platforms, such as the MicroStrategy® platform, may provide “live” and accessible databases to the participant trading partners, and may do so without altering the underlying data from the system supplier and/or retailer databases 204, 208, 212. The BI Report Generator 404, optionally through a third-party platform, may provide a BI application and user interface through which the participant trading partners may perform ad-hoc analysis of the data in their database(s), typically through a network portal or other web application, as described in further detail below. In one embodiment, the BI Report Generator 404 may provide one or more reports based on trading partner-defined report definitions or attributes dynamically selected by trading partners for inclusion in the report(s).

The Dashboard Creator 406 may be used to create Internet or network based high level executive user “dashboards” and summaries. The network based dashboards may be provided in, for example, in HTML format or any other suitable Internet programming language, so as to be accessible via a network, such as the Internet. The Dashboard Creator 406 may poll the underlying system supplier and/or retailer databases 204, 208, 212, and in one particular embodiment, the underlying system supplier and/or retailer dashboard databases 216, 218, for an identification of the data that is ready for reporting. Similar in manner to the Spreadsheet Report Generator 402, particular data may be selected out of a participant trading partners underlying database(s) and stored in a web-facing data store, such as a SQL Server, the web-facing data store being “live” and accessible to the participant trading partner. What is generated on a dashboard may be predetermined by analysts, who for example, may have generally defined a report definition (e.g., determining the layout, format, font, color, and data elements of the report), which is stored in metadata associated with the data or database(s). In this regard, in one embodiment, the Dashboard Creator 406 may generally deliver reports based on predetermined report definitions. In one embodiment, the Dashboard Creator 406 may utilize a third-party platform, such as that provided by LogiXML®, with Corporate Headquarters in McLean, Va. In one embodiment, a user or representative of the systems for trading partner intelligence among retailers and suppliers in the retail ecosystem described herein may, for each trading partner, configure the dashboard generated by the Dashboard Creator 406 for such trading partner based on attributes pre-determined or pre-selected by the respective trading partner. As also noted above, the Dashboard Creator 406, as well as any other BI applications, may be sourced from the same channel or provider as any other BI application, and may form just a part of a larger, encompassing BI application, such as but not limited to, a BI application based on the MicroStrategy® platform discussed above.

The network portal subsystem 500 generally provides an interactive network or internet trading partner interface for participant trading partners 502 to access the BI applications and perform business intelligence analysis on the data of their associated supplier and/or retailer databases 204, 208, 212. The network portal subsystem 500 may comprise a web portal platform or application 504, which is essentially a portal to, or a “wrapper” around, the BI applications, such as the Spreadsheet Report Generator 402, BI Report Generator 404, and Dashboard Creator 406 specifically described above, through which participant trading partners 502 have access over a network connection 506. In one embodiment, the web portal application 502 may be provided utilizing the ASP.Net server-side web application framework. The network portal subsystem 500 or web portal application 504 may also comprise a user/admin system 508, which may manage and store participant trading partner user data, such as but not limited to, username/password information and/or other authorization credentials, such as credentials identifying to which BI applications or other tools any particular trading partner has subscribed access. The web portal application 504 essentially provides a mechanism for users to view the information generated by the BI applications, such as the information generated by the Spreadsheet Report Generator 402, BI Report Generator 404, and Dashboard Creator 406.

In one embodiment, one or more of the BI applications may provide an intelligent item account feature, which can provide more effective item descriptions among particular trading partner relationships. In one embodiment, an intelligent item account feature may permit, for example, a trading partner (such as a supplier) to select one or more specific item attributes (e.g., item name, item price, item description, or the like) for identifying an item in the resulting information generated by a BI application configured for another particular trading partner (such as a specifically identified retailer with which the supplier has a business relationship).

In another embodiment, one or more of the BI applications may automatically prune information from display or inclusion in the results generated by the one or more BI applications. For example, one or more of the BI applications may automatically prune a dataset or information relating thereto from display or inclusion in the results generated by the one or more BI applications where there has been no activity in such dataset or no activity over some predetermined recent period of time. In one particular embodiment, for example, a BI application may permit a trading partner to select, from one or more dropdown menus, the information that will be shown or included in the resulting information generated by the BI application. In such case, information from datasets where there has been no activity or no activity over some predetermined recent period of time may be excluded from the dropdown menus for convenience to the trading partner.

In some embodiments, systems and methods for data acquisition, data warehousing, and providing business intelligence in a retail ecosystem described herein may provide a trading partner with a manner for restricting the access to particular BI application(s) or to particular information generated by any given BI application for different user/employee of the trading partner or otherwise providing different security access based on some attribute defining one or more users. For example, a trading partner may restrict access to one or more BI applications or particular information generated by a BI application on a company role basis (i.e., role-based security), on a user-by-user basis (i.e., user-based security), on a brand basis, on a geographic basis, on a particular trading partner relationship basis (e.g., which retailer(s) an employee of a supplier trading partner works with), or on any other suitable basis which defines a group of one or more user/employees of the trading partner. In one embodiment, an interface may be provided for authorizing different access levels through the network portal subsystem 500. In one embodiment, the trading partner may inform, through any conventional methods, a representative of the systems for data acquisition, data warehousing, and providing business intelligence in a retail ecosystem described herein, and the representative may utilize the network portal subsystem to authorize or generate the various access levels based on the information provided by the trading partner. In another embodiment, a trading partner may utilize the network portal subsystem directly in order to authorize or generate the various access levels. In this regard, trading partners may determine how much content is seen by which of its users.

Having described the high level subsystems of various embodiments of the present disclosure, it is recognized that the various embodiments may also include one or more quality control mechanisms for validating, verifying receipt of, or otherwise checking up on the data as it moves from the data acquisition subsystem 100 to the network portal subsystem 500. In one embodiment, for example, the data acquisition subsystem 100 may implement and deploy high-level quality control checks on the received or retrieved data. For example but not limited to, the data acquisition subsystem 100 may check whether expected data is on time or not, whether received or retrieved data is in the correct or an otherwise expected format, whether the exact same content has been previously received or retrieved, whether the size of the received or retrieved data is in a specified tolerance of what is expected, or any other suitable high level quality control measures.

Likewise, in one embodiment, for example, the data warehousing subsystem 200 may implement and deploy additional lower level or higher intelligence quality control checks on the data. For example but not limited to, the data warehousing subsystem 200 may check that data values in the data files are within predetermined tolerance thresholds, that certain data in a data file that is consistently received (such as a store number, item record, UPC number, etc.) is in fact present in the data, that values expected to be greater than zero are in fact at least zero, or any other suitable quality control measures, such as those which may not typically be checkable at the time of data acquisition.

In one embodiment, for example, the BI applications subsystem 400 may implement and deploy quality control for the generated reports. For example but not limited to, the BI applications subsystem 400 may check to make sure that reports are generating in a timely manner, that reports are populating with full data sets, that reports created match the data in the back-end system databases, or any other suitable quality control measures relating to the reports or that otherwise may not typically be checkable at the time of data acquisition or data warehousing.

Similarly, in one embodiment, for example, the network portal subsystem 500 may implement and deploy quality control relating to participant trading partner access to the generated reports and front-facing databases. For example but not limited to, the network portal subsystem 500 may check to make sure that the network portal subsystem 500 is up and running and is accessible to the participant trading partners, that reports are executing for the trading partners in a timely manner, or any other suitable quality control measures relating to participant trading partner access to the reports or front-facing databases or that otherwise may not typically be checkable at the time of data acquisition, data warehousing, or report generating.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method for providing business intelligence information relating to exchanges of goods in a retail ecosystem, the method comprising:
acquiring electronic data, through an electronic network, from a plurality of trading partners of the retail ecosystem, the electronic data relating to goods exchanged between the trading partners;
transforming the electronic data to a normalized format and storing the transformed data in the normalized format in a plurality of structured databases stored on a computer-readable storage medium, wherein at least one structured database is associated with each trading partner;
presenting through a business intelligence tool, accessible to the trading partners through an electronic network and displayable on an electronic display device, at least a portion of the data from one or more of the structured databases in a predetermined report structure.

2. The method of claim 1, wherein acquiring electronic data comprises polling one or more of the trading partners through the electronic network for new data and acquiring the new data.

3. The method of claim 1, further comprising monitoring metadata to identify whether data was expected to be received by any given trading partner.

4. The method of claim 1, further comprising supplementing data in a first of the structured databases automatically with data from a second of the structured databases.

5. The method of claim 4, wherein the first structured database is associated with a retailer and the second structured database is associated with a supplier of the retailer.

6. The method of claim 4, wherein the first structured database is associated with a supplier and the second structured database is associated with a retailer purchasing product from the supplier.

7. The method of claim 1, wherein at least a portion of the electronic data stored in each of the structured databases comprises sets of data, each set of data identifying a product sold, when the product was sold, and to where the product was sold.

8. The method of claim 7, wherein the predetermined report structure presented through the business intelligence tool is defined by a set of report rules.

9. The method of claim 8, wherein the report rules for at least some of the predetermined reports are defined by non-trading partners.

10. The method of claim 8, wherein the report rules for a predetermined report accessible to a given trading partner are defined by that trading partner.

11. The method of claim 1, wherein the business intelligence tool comprises a suite of business intelligence tools.

12. The method of claim 11, further comprising determining an access level for a user of a given trading partner and basing authorized access by the user to at least one of one or more of the business intelligence tools and data in the plurality of structured databases based on the determination of the access level for the user.

13. The method of claim 11, further comprising permitting any given trading partner to subscribe to one or more of the business intelligence tools, providing access by the given trading partner to only those business intelligence tools subscribed to.

14. A system for providing business intelligence information relating to exchanges of goods in a retail ecosystem, the system comprising:
a communications subsystem, operably connected with an electronic network, acquiring electronic data, through the electronic network, from a plurality of trading partners of the retail ecosystem, the electronic data relating to goods exchanged between the trading partners;
a data warehousing subsystem transforming the electronic data to a normalized format and storing the transformed data in the normalized format in a plurality of structured databases stored on a computer-readable storage medium, wherein at least one structured database is associated with each trading partner; and
a business intelligence tool, accessible to a given trading partner through an electronic network and displayable on an electronic display device, the business intelligence tool presenting at least a portion of the data from the at least one structured database associated with the given trading partner in a predetermined report structure.

15. The system of claim 14, wherein at least a portion of the electronic data stored in each of the structured databases comprises sets of data, each set of data identifying a product sold, when the product was sold, and to where the product was sold.

16. The system of claim 15, wherein the business intelligence tool comprises a suite of business intelligence tools.

17. The system of claim 16, wherein at least one of the business intelligence tools is a spreadsheet report generator that produces an interactive spreadsheet report based on data from one or more of the plurality of structured databases.

18. The system of claim 16, wherein at least one of the business intelligence tools is a business intelligence report generator that produces a report for a given trading partner relating to data from one or more of the plurality of structured databases based on ad-hoc reporting options selected by the given trading partner.

19. The system of claim 16, wherein at least one of the business intelligence tools is a dashboard utility that generates an Internet-based dashboard display for a given trading partner relating to data from one or more of the plurality of structured databases based on a predetermined configuration defined for that given trading partner.

20. The system of claim 19, wherein the predetermined configuration is based on attributes pre-selected by the given trading partner.
